(19) United States
(12) Patent Application Publication
(10) Pub. No.: US 2023/0316396 A1
(43) Pub. Date: Oct. 5, 2023

(54) Trading System and Method for Commodity Distribution

(71) Applicant: John Woodard, Fort Worth, TX (US)

(72) Inventor: John Woodard, Fort Worth, TX (US)

(21) Appl. No.: 17/708,022

(22) Filed: Mar. 30, 2022

(51) Int. Cl. G06Q 40/04; G06Q 30/0201

(52) U.S. Cl. CPC G06Q 40/04; G06Q 30/0201

(57) ABSTRACT

Disclosed are a trading system and method for commodity distribution. The method includes receiving data of one or more organizations looking for one or more producers based on one or more employees of the organizations. The method includes matching the organizations with the one or more producers. The method includes identifying one or more deals for the organizations and one or more employers of the organizations based on a placement in a market for purchasing one or more commodities from the producers. The method includes identifying one or more third-party processors to customize the one or more commodities of the organizations. The method includes obtaining information of a delivery location associated with the one or more commodities. The method includes facilitating an administrator to transfer the one or more commodities to the delivery location upon the customization of the one or more commodities as per the requirement of the organizations.

### TECHNICAL FIELD

The presently disclosed embodiments are related, in general, to data processing and trading system and method. More particularly, the presently disclosed embodiments are related to methods and systems for commodity distribution.

### BACKGROUND

Currently, a few powerful companies control the majority market share of various grocery items bought regularly by ordinary citizens. A few companies dominate the complete food supply chain: from seeds and fertilizers to slaughterhouses and supermarkets to cereals and beers. It also means those who harvest, pack and sell the food have the least control and power. Farms and meat processing plants are among the most dangerous and exploitative workplaces in the country.

This specification recognizes that there is a need for breaking the commodity pricing monopoly of food manufacturers have on the public of developed countries. Further, there is a need for an efficient and automated trading system and method for commodity distribution over a digital platform.

Further limitations and disadvantages of conventional approaches will become apparent to one of skill in the art, through comparison of described systems with some aspects of the present disclosure, as set forth in the remainder of the present application and with reference to the drawings.

### SUMMARY

According to embodiments illustrated herein, there may be provided a trading method for commodity distribution. The method includes receiving, by one or more processors, contact data of one or more organizations looking for one or more producers based on a requirement of one or more employees of the organizations. The method includes matching, by the one or more processors, the organizations with the one or more producers. The method includes optionally, identifying, by the one or more processors, one or more suitable deals for the organizations and one or more employers of the organizations based on a placement of the organizations in a market for purchasing one or more commodities from the producers. The method includes identifying, by one or more processors, one or more third-party processors to customize the one or more commodities as per the requirement of the organizations. The method includes obtaining, by one or more processors, information of a delivery location associated with one or more commodities. The method includes facilitating, by the one or more processors, an administrator to transfer the one or more commodities to the delivery location upon the customization of the one or more commodities as per the requirement of the organizations.

According to embodiments illustrated herein, there may be provided a trading system that includes an application server configured for commodity distribution. The application server may further include one or more processors configured to receive contact data of one or more organizations looking for one or more producers based on a requirement of one or more employees of the organizations. The application server may further include one or more processors configured to match the organizations with one or more producers. The application server may further include one or more processors configured to optionally, identify one or more suitable deals for the organizations and one or more employers of the organizations based on a placement of the organizations in a market for purchasing one or more commodities from the producers. The application server may further include one or more processors configured to identify one or more third-party processors to customize the one or more commodities as per the requirement of the organizations. The application server may further include one or more processors configured to obtain information of a delivery location associated with one or more commodities. The application server may further include one or more processors configured to facilitate an administrator to transfer one or more commodities to the delivery location upon the customization of one or more commodities as per the requirement of the organizations. The application server may further include a memory communicatively coupled to one or more processors, wherein the memory stores instructions executed by the processors.

Accordingly, one advantage of the present invention is that it allows customers to perform commodity trade that allows them to break away from being end-user at a grocery store or a restaurant reacting to price increases and decreases. Being able to trade gives the customers a chance to obtain cheaper prices for meats based on the market themselves.

Accordingly, one advantage of the present invention is that it allows customers to invest and input their purchased meats into the restaurant market that will increase small businesses as they are more likely to take in the meat for business as compared to larger companies (corporations are more likely to get approval from corporate as it ruins the “reliability” of fast food). The investment into local culture/food in communities increases as well. This also increases locally bought high-quality food if a company buys food from employee paychecks.

Accordingly, one advantage of the present invention is that it offers a way to feed families with high-quality items and use their company name for economically cheaper foods. As employees are requesting more for their employers.

The aforementioned features and advantages of the present disclosure may be appreciated by reviewing the following description of the present disclosure, along with the accompanying FIGURES, wherein like reference numerals refer to like parts.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments of the trading method and the trading system may be implemented;

FIG. 2 is a block diagram that illustrates an application server configured for commodity distribution, in accordance with at least one embodiment;

FIG. 3 is a flowchart that illustrates a trading method for commodity distribution, in accordance with at least one embodiment;

FIG. 4 illustrates a block diagram of an exemplary computer system for implementing embodiments consistent with the present disclosure; and

FIG. 5 is an operational flowchart that illustrates an example of the present trading method for commodity distribution, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

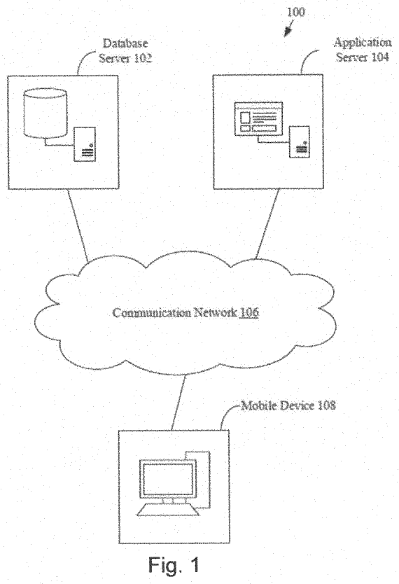

FIG. 1 is a block diagram that illustrates a system environment in which various embodiments of the trading method and the trading system may be implemented. The invention provides a digital product marketplace in which the producers, employees of the organizations, processors, and the related business community can continuously interact and facilitate transactions by efficiently exchanging accurate and standardized information.

The system environment 100 may include a database server 102, an application server 104, a communication network 106, and one or more mobile devices 108a. 108b, . . . , 108n collectively referred to with the numeral 108 that may be associated with one or more users (not shown). The database server 102, the application server 104, and the one or more mobile devices 108 may be communicatively coupled with each other via the communication network 106. In an embodiment, the application server 104 may communicate with the database server 102 using one or more protocols such as, but not limited to, Open Database Connectivity (ODBC) protocol and Java Database Connectivity (JDBC) protocol. In an embodiment, one or more mobile devices 108 may communicate with the application server 104, via the communication network 106.

In an embodiment, the database server 102 may refer to a computing device that may be configured to store the content related to trading and commodities. In an embodiment, the database server 102 may include a special-purpose operating system specifically configured to perform one or more database operations on the content related to trading and commodities. Examples of database operations may include, but are not limited to, Select, Insert. Update, and Delete. In an embodiment, the database server 102 may include hardware that may be configured to perform one or more predetermined operations. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like.

In an embodiment, the database server 102 may be configured to utilize the application server 104 for commodity distribution. The database server 102 may be configured to transmit the content related to commodity distribution to the application server 104 for data processing, via the communication network 106. In an embodiment, the database server 102 may be configured to transmit the content related to commodity distribution to one or more devices at one or more locations for showcasing the content related to commodity distribution.

A person with ordinary skills in the art will understand that the scope of the disclosure is not limited to the database server 102 as a separate entity. In an embodiment, the functionalities of the database server 102 can be integrated into the application server 104.

In an embodiment, the application server 104 may refer to a computing device or a software framework hosting an application or a software service. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The application server 104 may be realized through various types of application servers such as, but are not limited to, a Java application server, a .NET framework application server, a Base4 application server, a PHP framework application server, or any other application server framework.

In an embodiment, the application server 104 may be configured to receive contact data of one or more organizations looking for one or more producers based on a requirement of one or more employees of the organizations. The application server 104 may be configured to match the organizations with the one or more producers. According to an embodiment herein, examples of the producers include but are not limited to the suppliers, and manufacturers of the commodities, meat, etc. The application server 104 may be configured to optionally, identify one or more suitable deals for the organizations and one or more employers of the organizations based on a placement of the organizations in a market for purchasing one or more commodities from the producers. According to an embodiment herein, the employers or the organizations are selling the commodities to their employees. Further, the organizations are purchasers of the goods from producers.

The application server 104 may be configured to identify one or more third-party processors to customize the one or more commodities as per the requirement of the organizations. The application server 104 may be configured to obtain information of a delivery location associated with the one or more commodities. The application server 104 may be configured to facilitate an administrator to transfer the one or more commodities to the delivery location upon the customization of the one or more commodities as per the requirement of the organizations.

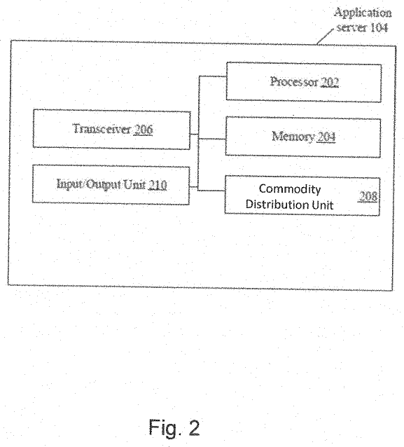

The application server 104 may further include a memory 204 (shown in FIG. 2) communicatively coupled to one or more processors 202 (shown in FIG. 2), wherein the memory 204 stores instructions executed by the processors 202. In an embodiment, the memory 204 and processor 202 are configured to display a plurality of factors based on the organization that bought the product in collaboration with the producers and the third-party processors. In an embodiment, the memory 204 and processor 202 are configured to capture trading data and process the trading data in a database; and initiate a signaling the transfer of the commodities to the delivery location of a desired regional center. According to an embodiment herein, the desired regional center is a destination location where the commodities need to be delivered.

In an embodiment, the memory 204 and processor 202 are configured to negotiate an agreement of the transfer of the one or more commodities with the one or more organizations and the producers. According to an embodiment herein, the organizations are the buyer and their employees are consumers. In an embodiment, the memory 204 and processor 202 are configured to facilitate the administrator to deliver the one or more commodities on a delivery basis based on the negotiation. In an embodiment, the one or more third-party processors customize the one or more commodities by performing one or more of packaging, cutting, and processing the one or more commodities to match the requirement of the organizations. If the commodity/product isn't packaged, cut, or processed as per the requirement of the organization/group ordering by the producers, the third-party processors will do this job to match the requirement.

A person having ordinary skill in the art will appreciate that the scope of the disclosure is not limited to realizing the application server 104 and the one or more mobile devices 108 as separate entities. In an embodiment, the application server 104 may be realized as an application program installed on and/or running on one or more mobile devices 108 without departing from the scope of the disclosure.

In an embodiment, the communication network 106 may correspond to a communication medium through which the database server 102, the application server 104, and the one or more mobile devices 108 may communicate with each other. Such communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 may include but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

In an embodiment, the one or more mobile devices 108 may refer to a computing device used by one or more users. The one or more mobile devices 108 may comprise of one or more processors and one or more memories. The one or more memories may include computer-readable code that may be executable by one or more processors to perform predetermined operations. In an embodiment, the one or more mobile devices 108 may present a user-interface, received from the application server 104, to the one or more users to display the content related to trading and commodities on a display screen of the one or more mobile devices 108 associated with the one or more users. Examples of the one or more mobile devices 108 may include but are not limited to, a personal computer, a laptop, a personal digital assistant (PDA), a mobile device, a tablet, or any other computing device.

FIG. 2 is a block diagram that illustrates an application server 104 configured for commodity distribution, in accordance with at least one embodiment. FIG. 2 is explained in conjunction with elements from FIG. 1. In an embodiment, the application server 104 includes a processor 202, a memory 204, a transceiver 206, a commodity distribution unit 208, and an input/output unit 210. The processor 202 may be communicatively coupled to the memory 204, the transceiver 206, commodity distribution unit 208, and the input/output unit 210. The transceiver 206 may be communicatively coupled to the communication network 106.

The processor 202 comprises suitable logic, circuitry, interfaces, and/or code that may be configured to execute a set of instructions stored in the memory 204. The processor 202 may be implemented based on several processor technologies known in the art. The processor 202 works in coordination with the transceiver 206, the commodity distribution unit 208, and the input/output unit 210 for commodity distribution. Examples of the processor 202 include but are not limited to, an X86-based processor, a Reduced Instruction Set Computing (RISC) processor, an Application-Specific Integrated Circuit (ASIC) processor, a Complex Instruction Set Computing (CISC) processor, and/or other processors.

The memory 204 comprises suitable logic, circuitry, interfaces, and/or code that may be configured to store the set of instructions, which are executed by the processor 202. In an embodiment, the memory 204 may be configured to store one or more programs, routines, or scripts that are executed in coordination with the processor 202. The memory 204 may be implemented based on a Random-Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that may be configured to receive the content related to trading and commodities from the database server 102, via the communication network 106. The transceiver 206 may be further configured to transmit the content related to trading and commodities to one or more display screens of the mobile devices 108, via the communication network 106. The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN), and/or a metropolitan area network (MAN). The wireless communication may use any of a plurality of communication standards, protocols, and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The commodity distribution unit 208 comprises suitable logic, circuitry, interfaces, and/or code that may be configured to receive contact data of one or more organizations looking for one or more producers based on a requirement of one or more employees of the organizations. The commodity distribution unit 208 may be further configured to match the organizations with the one or more producers. The commodity distribution unit 208 may be further configured to optionally, identify one or more suitable deals for the organizations and one or more employers of the organizations based on a placement of the organizations in a market for purchasing one or more commodities from the producers. The commodity distribution unit 208 may be further configured to identify one or more third-party processors to customize the one or more commodities as per the requirement of the organizations. The commodity distribution unit 208 may be further configured to obtain information of a delivery location associated with the one or more commodities. The commodity distribution unit 208 may be further configured to facilitate an administrator to transfer the one or more commodities to the delivery location upon the customization of the one or more commodities as per the requirement of the organizations

The input/output unit 210 comprises suitable logic, circuitry, interfaces, and/or code that may be configured to provide one or more inputs to the application server 104 during the commodity distribution. The input/output unit 210 comprises various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

In operation, the processor 202 works in coordination with the transceiver 206, the commodity distribution unit 208, and the input/output unit 210 to provide a digital platform for commodity distribution. In an embodiment, the one or more mobile devices 108 of the one or more users may be configured to receive contact data of one or more organizations looking for one or more producers based on a requirement of one or more employees of the organizations. In an embodiment, the transceiver 206 may be configured to match the organizations with the one or more producers. In an embodiment, the transceiver 206 may be configured to optionally, identify one or more suitable deals for the organizations and one or more employers of the organizations based on a placement of the organizations in a market for purchasing one or more commodities from the producers. In an embodiment, the transceiver 206 may be configured to identify one or more third-party processors to customize the one or more commodities as per the requirement of the organizations. In an embodiment, the transceiver 206 may be configured to obtain information of a delivery location associated with the one or more commodities. In an embodiment, the transceiver 206 may be configured to facilitate an administrator to transfer the one or more commodities to the delivery location upon the customization of the one or more commodities as per the requirement of the organizations.

A person skilled in the art will understand that the scope of the disclosure should not be limited to the creation of the elate of one or more advertisements, and one or more endorsements based on the aforementioned factors and using the aforementioned techniques. Further, the examples provided in the specification are for illustrative purposes and should not be construed to limit the scope of the disclosure.

The present invention provides a digital product marketplace in which the producers, employees of the organizations, and processors can continuously interact and facilitate transactions by efficiently exchanging accurate and standardized information. In this digital product marketplace, the present trading system optionally works with companies/organizations to find the best deals with producers for their employees/group members wants and needs while helping the company bring in exclusive deals. That goes into the marketplace exclusively. In this digital product marketplace, the present invention allows organizations to trade on behalf of those who own part of that commodity (an example being the employees) given a company can get more for the product they have while trading from their name and size of the product.

In the digital product marketplace, the present invention displays the most recent trades for the specific type of product being offered in the market compared to interest. Including most recent trades and commodity market indexes/news concerning an organization's interest. Based on the location of the employee or employer, the present invention displays which inputs will take in the product before trading is completed. The present invention allows employees to talk before the product hits the market that they'll let the company trade for them, let the employee trade from themselves, or have the best option for what they want. After trading is completed, we offer the consumers the chance to engage with end services to discuss services for input on a product, investment on a product, or buy outright. The present invention allows those associated with an organization to pull from their organization during the querying period after trading has been completed.

In operation, the present invention initiates with two options from the beginning. In the first step, organizations looking for producers are contacted, based on what the employees want and need. The present invention would match that company to one of our verified producers. In an option first step, the organizations looking to play into the marketplace would find the best deals for them and their employers based on their placement in the market for purchasing meat/food from producers. In the second step, if the product isn't packaged, cut, or processed to the liking of the organization/group order, we will find third-party processors to match that demand. Or use our processing centers. In the third step, the present invention obtains information on the location the meat/food needs to be transferred. In the fourth step, once the product is in the correct condition as requested, the present invention works with these third parties processors or the producers and transfer the product to the correct regional location. In more detail, the employees/group members would agree that if the product is bought with their organization, they would allow their employer/organization to trade for them, let the employee trade for themselves, or let the employee take the option to choose a more specific deal. The correct regional location will help mitigate any confusion so companies aren't trading products that an employee has opted for their company to not trade on their behalf. Further, the present invention begins the process of grading the product ourselves and inputting them into the marketplace for trading from the regional location. Giving the product ratings and more detailed descriptions. Although the meat should've been graded already from the USDA, if not the present invention may bring in a USDA official. The present invention begins to input the interests of the organization or the individual in a querying period as the platform begins searching the marketplace to look for recommendations already in the marketplace to match the demand wanted. Where the food is being accepted, the amount of food, locations of resources, etc. At the fifth step, in the marketplace, based on the organization that bought the product in collaboration with others the UI would display multiple factors. On a company level, it would display current products in the market associated with the organization and wanted products by the organization. You would be able to drill down on an employee/location level and look for specific products that match what you're looking for. You would reach out to initiate a trade. A notification would go to the organization and the group member. Based on how the agreement was set, the organization or the group member would agree to the trade.

In the sixth step, after trading is complete, we would begin the intake of information. Processing the trade into our databases and begin signaling the transfer of products to the desired regional center. Although no products will move until the negotiation process is completed as well. In the seventh step, also begins the negotiation stage of this process. meaning that because there was an agreement on the transfer of products, you would want to begin to use the new product immediately. Companies that could take your product for input would have offers conditional based on location, performance, and whatever they deemed necessary. If you choose to store your produce, it will be taken off the marketplace and brought back in if indicated to do so. In eight-step, based on how the contract or buying is set with an end-user (inputs), we would send the meat/produce on a delivery basis.

In an embodiment, the present trading system determines when commodity prices are increasing. The present invention looks into commodity prices from multiple indexes. Then the present trading system shows multiple trades concerning your interests built down from a high to a lower level meaning from an overall product level down to the grade of the food, location-based, etc. Further, the present trading system also displays the increases or decreases of what end-users will take the product currently in the marketplace.

According to an embodiment herein, the present trading system determines when the customer is interested to buy/using the services/commodities. To display interest, a user would need to make a personal account. The present trading system then makes a link process that connects to your organization. As an individual, the user would submit buying interests to your company's account. Organizations would also need to make their accounts so that group members can attach themselves too. Further, the producers need to make their accounts as well for the back end of the trading process. During the trading process, the commodity that is up for sale will be available underneath an offer tab in the organization or the group member's account.

According to an embodiment, the present trading system adds a contract score. Based on consumer's agreements with a restaurant or store to use consumer's input, if the consumer does not follow on the consumer's side of the contract and it is broken. The consumer will have a contract score so other stores can see if the consumer upholds the consumer's side of a contract.

Further, the present trading system adds a fire sale component where a producer could offer a nice deal to a person who has products in storage. If there's a winter storm and a burger place can't source their beef, they would reach out to the owner of the product in storage for an agreed-upon deal.

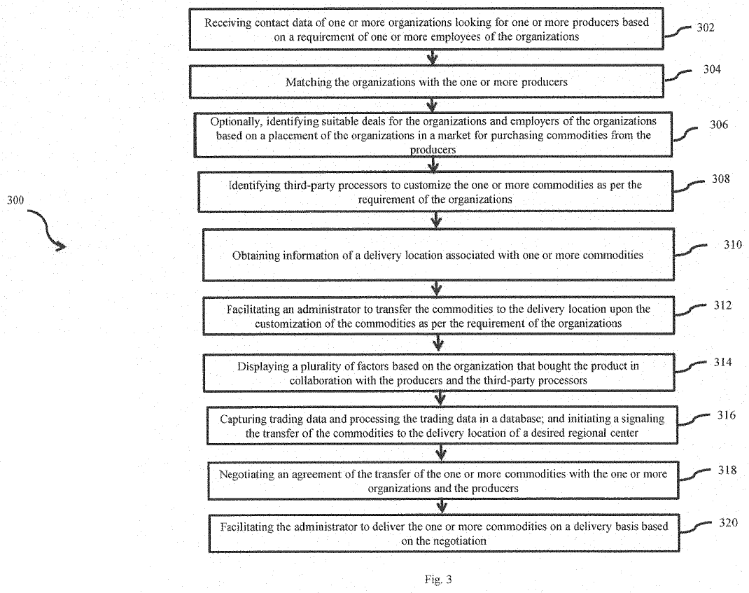

FIG. 3 is a flowchart 300 that illustrates a trading method for commodity distribution, in accordance with at least one embodiment. The flowchart 300 is described in conjunction with FIG. 1 and FIG. 2. The method includes a step 302 of receiving, by one or more processors, contact data of one or more organizations looking for one or more producers based on a requirement of one or more employees of the organizations. The method includes a step 304 of matching, by the one or more processors, the organizations with the one or more producers. The method includes a step 306 of optionally, identifying, by the one or more processors, one or more suitable deals for the organizations and one or more employers of the organizations based on a placement of the organizations in a market for purchasing one or more commodities from the producers. The method includes a step 308 of identifying, by one or more processors, one or more third-party processors to customize the one or more commodities as per the requirement of the organizations. The method includes a step 310 of obtaining, by one or more processors, information of a delivery location associated with one or more commodities. The method includes a step 312 of facilitating, by the one or more processors, an administrator to transfer the one or more commodities to the delivery location upon the customization of the one or more commodities as per the requirement of the organizations. The method includes a step 314 of displaying, by the one or more processors, a plurality of factors based on the organization that bought the product in collaboration with the producers and the third-party processors. The method includes a step 316 of capturing, by the one or more processors, trading data and processing the trading data in a database; and initiating a signaling the transfer of the commodities to the delivery location of a desired regional center. The method includes a step 318 of negotiating, by the one or more processors, an agreement of the transfer of the one or more commodities with the one or more organizations and the producers. The method includes a step 320 of facilitating, by the one or more processors, the administrator to deliver the one or more commodities on a delivery basis based on the negotiation. In an embodiment, the one or more third-party processors customize the one or more commodities by performing one or more of packaging, cutting, and processing the one or more commodities to match the requirement of the organizations.

### Computer System

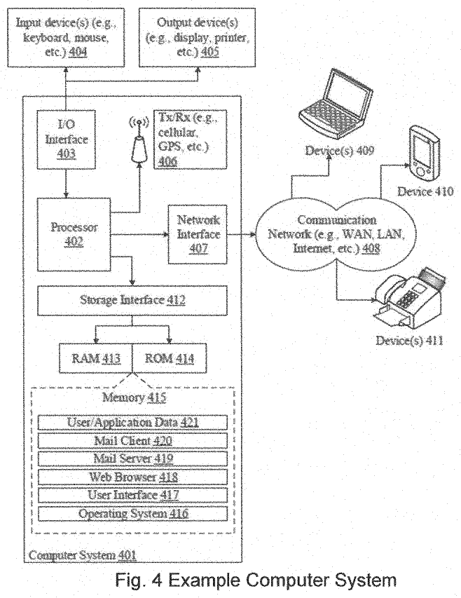

FIG. 4 illustrates a block diagram of an exemplary computer system for implementing embodiments consistent with the present disclosure. Variations of computer system 401 may be used for performing optical character recognition on an image including a plurality of printed characters. The computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating-point units, graphics processing units, digital signal processing units, etc. The processor may include a microprocessor, such as AMD Athlon, Duron, or Opteron, ARM's application, embedded or secure processors, IBM PowerPC, Intel's Core, Itanium, Xeon, Celeron or other lines of processors, etc. The processor 402 may be implemented using a mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, a global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 402 may be disposed of in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent disks (RAID), solid-state memory devices, solid-state drives, etc.

The memory devices may store a collection of program or database components, including, without limitation, an operating system 416, the user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, checkboxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP. ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

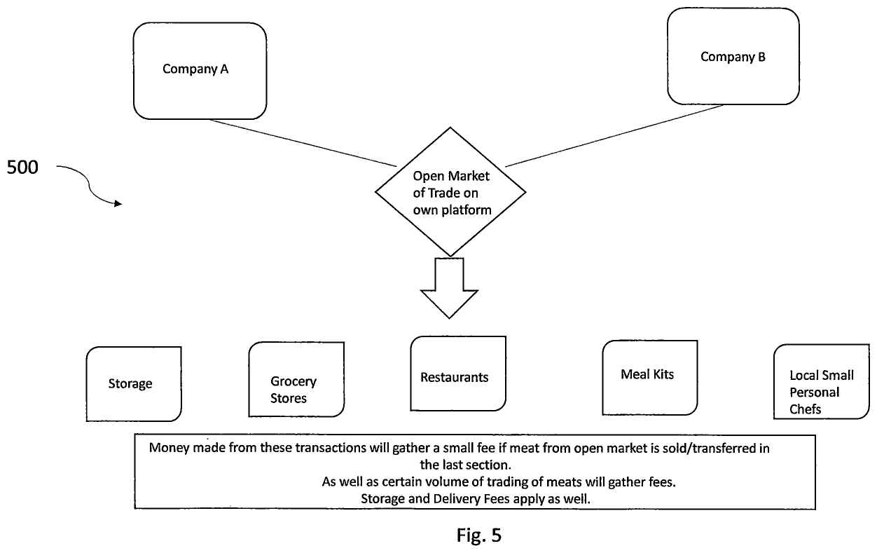

FIG. 5 is an operational flowchart that illustrates an example of the present trading method for commodity distribution, in accordance with at least one embodiment. The present invention provides meat buying services for groups/individuals, or companies. The meat bought would be traded on an open market or put into storage for later usage. For example, company A could get cheaper meats prices on beef because of their placement in the market. Company B cheaper meat prices on seafood because of their placement in the market. Trading the meat on an open market platform. The only meat that is USDA approved and facilitated by the company will be traded on the platform. Meat from this digital platform would be used to input, invest, cheapen, or store at multiple places of businesses.

For grocery stores, the users would be able to go to a grocery store and trade meats for other foods. Invest meat bought to go into grocery stores at a cheaper price so when other meat prices skyrocket from certain events (Weather, Shortage, etc) customers can compete with big brands that have a monopoly on the market.

For restaurants, determine what days you're coming in to eat at restaurants. If accepted, use the USDA-approved meat to lower the price of your burger, pasta, etc as the meat is a major input price to lower the meal and the business knows when a customer will come in. Invest meat into a restaurant if you believe in their menu products and can offer a higher quality of meat. For a percentage of sales or offer meat bought at a higher price. The users can invest a certain grade/cut of meat a restaurant may need and can get cheaper prices. For meal kits (e.g., HelloFresh, Blue Apron). The present invention uses meat as an input to lower the prices of meal kit companies as you have the meat already. For local chefs, the present invention sends to a local chef who offers to make food for certain people (high protein, no carbs, etc.) in a professional environment.

In an embodiment, the present trading system enables multiple groups' individuals/companies to trade on an open platform. Further, the meat is inputted from the open platform into grocery stores. Furthermore, the meat is inputted from the open platform into restaurants. The meat is inputted from the open platform into meal kits. Lastly, the meat is inputted from the open platform into local professional chefs. Overall sign-up and trading and final product.

The present disclosure may be realized in hardware or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above-disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A trading method for commodity distribution, comprising:
receiving, by one or more processors, contact data of one or more organizations looking for one or more producers based on a requirement of one or more employees of the organizations;
matching, by the one or more processors, the organizations with the one or more producers;
optionally, identifying, by the one or more processors, one or more suitable deals for the organizations and one or more employers of the organizations based on a placement of the organizations in a market for purchasing one or more commodities from the producers;
identifying, by the one or more processors, one or more third-party processors to customize the one or more commodities as per the requirement of the organizations;
obtaining, by the one or more processors, information of a delivery location associated with the one or more commodities; and
facilitating, by the one or more processors, an administrator to transfer the one or more commodities to the delivery location upon the customization of the one or more commodities as per the requirement of the organizations.

2. The method according to claim 1, comprises a step of displaying, by the one or more processors, a plurality of factors based on the organization that bought the product in collaboration with the producers and the third-party processors.

3. The method according to claim 1, comprises a step of capturing, by the one or more processors, trading data and processing the trading data in a database; and initiating a signaling the transfer of the commodities to the delivery location of a desired regional center.

4. The method according to claim 1, comprises a step of negotiating, by the one or more processors, an agreement of the transfer of the one or more commodities with the one or more organizations and the producers.

5. The method according to claim 1, comprises a step of facilitating, by the one or more processors, the administrator to deliver the one or more commodities on a delivery basis based on the negotiation.

6. The method according to claim 1, wherein the one or more third-party processors customize the one or more commodities by performing one or more of packaging, cutting, and processing the one or more commodities to match the requirement of the organizations.

7. A trading system for commodity distribution, comprising:
a processor;
a memory communicatively coupled to the processor, wherein the memory stores instructions executed by the processor, wherein the memory and processor are configured to:
receive contact data of one or more organizations looking for one or more producers based on a requirement of one or more employees of the organizations;
match the organizations with the one or more producers;
optionally, identify one or more suitable deals for the organizations and one or more employers of the organizations based on a placement of the organizations in a market for purchasing one or more commodities from the producers;
identify one or more third-party processors to customize the one or more commodities as per the requirement of the organizations;
obtain information of a delivery location associated with the one or more commodities; and
facilitate an administrator to transfer the one or more commodities to the delivery location upon the customization of the one or more commodities as per the requirement of the organizations.

8. The trading system according to claim 7, wherein the memory and processor are configured to display a plurality of factors based on the organization that bought the product in collaboration with the producers and the third-party processors.

9. The trading system according to claim 7, wherein the memory and processor are configured to capture trading data and process the trading data in a database; and initiate a signaling the transfer of the commodities to the delivery location of a desired regional center.

10. The trading system according to claim 7, wherein the memory and processor are configured to negotiate an agreement of the transfer of the one or more commodities with the one or more organizations and the producers.

11. The trading system according to claim 7, wherein the memory and processor are configured to facilitate the administrator to deliver the one or more commodities on a delivery basis based on the negotiation.

12. The trading system according to claim 7, wherein the one or more third-party processors customize the one or more commodities by performing one or more of packaging, cutting, and processing the one or more commodities to match the requirement of the organizations.
